(19) United States
(12) Patent Application Publication
(10) Pub. No.: US 2005/0219181 A1
(43) Pub. Date: Oct. 6, 2005

(54) Multi-gradation voltage generating apparatus including two gradation voltage generating circuits

(75) Inventor: Satoru Matsuda, Shiga (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kawasaki-shi (JP)

(21) Appl. No.: 11/092,625

(22) Filed: Mar. 30, 2005

(30) Foreign Application Priority Data
Mar. 31, 2004 (JP) 2004-101713

(51) Int. Cl. G09G 3/36

(52) U.S. Cl. 345/89

(57) ABSTRACT

In a multi-gradation voltage generating apparatus, a first gradation voltage generating circuit includes a series circuit formed by “M” (M=1, 2, . . . ) resistors. The series circuit has a first end adapted to receive a first reference gradation voltage from the exterior and a second end adapted to receive a second reference gradation voltage from the exterior. A second gradation voltage generating circuit includes “M” unit circuits each connected between ends of one of the resistors. Each of the unit circuits is constructed by one voltage divider and one voltage follower connected in series. The voltage divider is adapted to generate a plurality of gradation voltages.

### BACKGROUND OF THE INVENTION

1. Field of the Invention

The present invention relates to a multi-gradation voltage generating apparatus used in a signal line driver of a liquid crystal display (LCD) apparatus.

2. Description of the Related Art

Generally, an LCD apparatus is constructed by a panel including signal lines (or data lines) arranged along a column direction, scan lines (or gate lines) arranged along a row direction, pixels located at intersections between the signal lines and the scan lines, a signal line driver, and a scan line driver. Also, the signal line driver is constructed by a horizontal shift register, a data register, a data latch circuit, a level shifter, a digital/analog (D/A) converter, a multi-gradation voltage generating circuit and an output buffer (see: JP-8-211367-A). This multi-gradation voltage generating circuit is constructed by a series of resistors arranged along the row direction whose number is the same as that of required gradation voltages. This will be explained later in detail.

In the above-described prior art LCD apparatus, however, since the multi-gradation voltage generating circuit is large in size along the row direction, the LCD apparatus is increased in size.

### SUMMARY OF THE INVENTION

It is an object of the present invention to provide a multi-gradation voltage generating apparatus capable of being decreased in size.

Another object is to provide a signal line driver incorporating a multi-gradation voltage generating circuit capable of decreasing the size.

According to the present invention, in a multi-gradation voltage generating apparatus, a first gradation voltage generating circuit includes a series circuit formed by “M” (M=1, 2, . . . ) resistors. The series circuit has a first end adapted to receive a first reference gradation voltage from the exterior and a second end adapted to receive a second reference gradation voltage from the exterior. A second gradation voltage generating circuit includes “M” unit circuits each connected between ends of one of the resistors. Each of the unit circuits is constructed by one voltage divider and one voltage follower connected in series. The voltage divider is adapted to generate a plurality of gradation voltages.

### BRIEF DESCRIPTION OF THE DRAWINGS

The present invention will be more clearly understood from the description set forth below, as compared with the prior art, with reference to the accompanying drawings, wherein:

FIG. 1A is a plan view illustrating a prior art LCD apparatus;

FIG. 1B is a cross-sectional view of the LCD apparatus of FIG. 1A;

FIG. 2 is a block circuit diagram of the signal line driver of FIGS. 1A and 1B;

FIG. 3 is a graph showing the drive voltage to transmittance characteristics of the LCD panel of FIGS. 1A and 1B;

FIG. 4 is a circuit diagram of the multi-gradation voltage generating circuit of FIG. 2;

FIG. 5 is a block circuit diagram illustrating an embodiment of the signal line driver according to the present invention;

FIGS. 6 and 7 are circuit diagrams of first and second examples, respectively, of the multi-gradation voltage generating circuit of FIG. 5; and

FIGS. 8 and 9 are circuit diagrams of modifications of the multi-gradation voltage generating circuit of FIGS. 6 and 7, respectively.

### DESCRIPTION OF THE PREFERRED EMBODIMENT

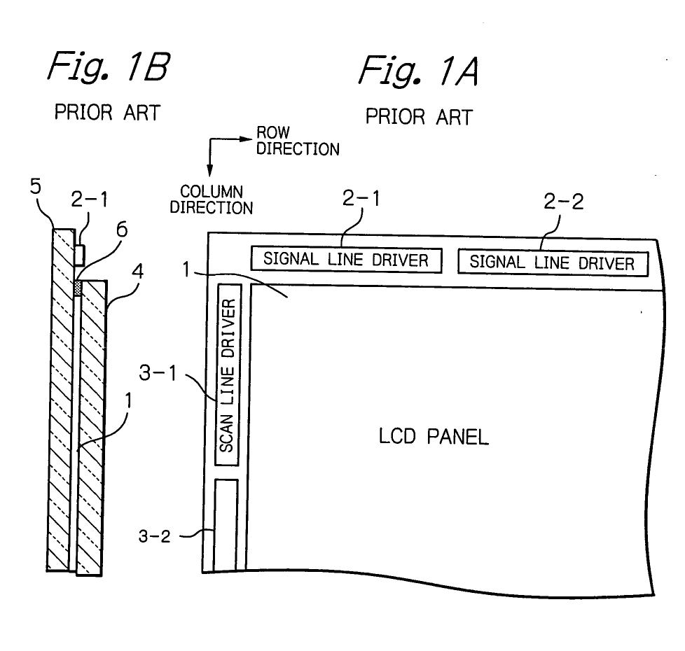

Before the description of the preferred embodiment, a prior art LCD apparatus will be explained with reference to FIGS. 1A, 1B, 2, 3 and 4.

In FIGS. 1A and 1B, which are plan view and a cross-sectional view, respectively, illustrating a prior art LCD apparatus, an LCD panel 1 including signal lines, scan lines, pixels each formed by one thin film transistor (TFT) and one pixel capacitor located at intersections between the signal lines and the scan lines is provided, and signal line drivers 2-1, 2-2, . . . for driving the signal lines and scan line drivers 3-1, 3-2, . . . for driving the scan lines are provided. Note that the signal line drivers 2-1, 2-2, . . . are manufactured by chips forming one signal line driver, and the scan line drivers 3-1, 3-2, . . . are manufactured by chips forming one scan line driver.

The panel 1 is sandwiched by two glass substrates 4 and 5, and is sealed by a sealing element 6 provided on the periphery thereof.

The signal line drivers 2-1, 2-2, . . . and the scan line drivers 3-1, 3-2, . . . are mounted by using a chip on glass (COG) method. That is, the signal line drivers 2-1, 2-2, . . . and the scan line drivers 3-1, 3-2, . . . are mounted on the outer periphery of the glass substrate 5 outside of the glass substrate 4. Note that the glass substrate 4 is smaller than the glass substrate 5.

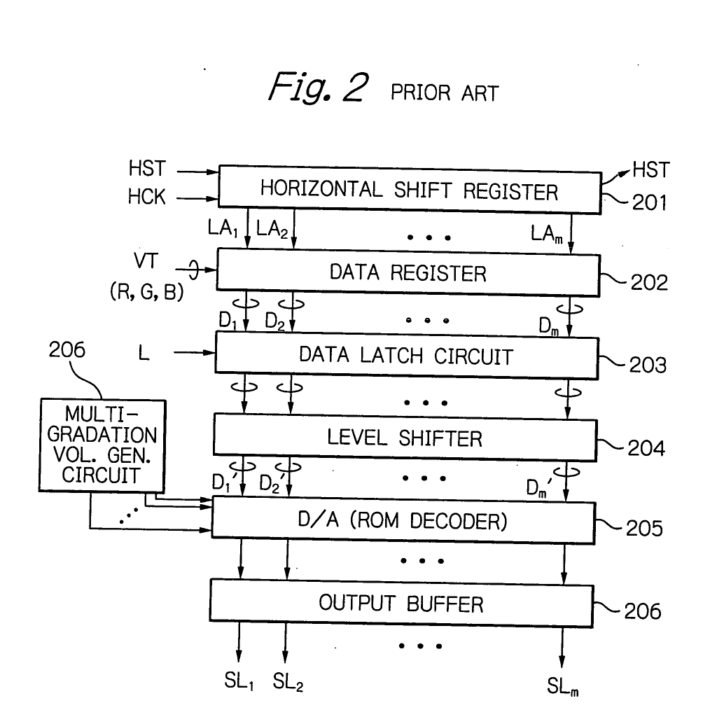

In FIG. 2, which is a detailed block circuit diagram of the signal line driver 2-1 of FIGS. 1A and 1B, the signal line driver 2-1 is constructed by a horizontal shift register 201, a data register 202, a data latch circuit 203, a level shifter 204, a D/A converter 205, a multi-gradation voltage generating circuit 206 and an output buffer 207 (see: JP-8-211367-A).

The horizontal shift register 201 shifts a horizontal start pulse signal HST in synchronization with a horizontal clock signal HCK, to sequentially generate latch signals LA₁, LA₂, . . . , LAₘ.

The data register 202 latches a digital gradation video signal VD formed by a red signal (R), a green signal (G) and a blue signal (B) in synchronization with the latch signals LA₁, LA₂, . . . , LAₘ, respectively, to generate digital video signals D₁, D₂, . . . , Dₘ, respectively.

The data latch circuit 203 latches the digital video signals D₁, D₂, . . . , Dₘ of the data register 202 in synchronization with a load signal L.

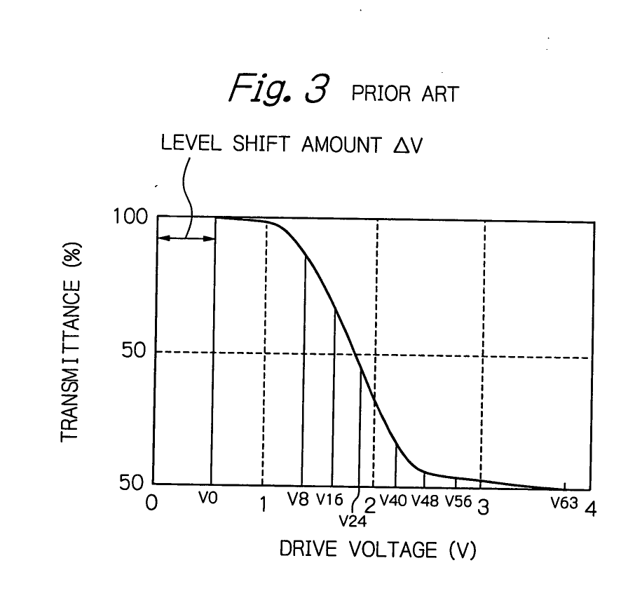

The level shifter 204 shifts the digital video signals D₁, D₂, . . . , Dₘ by a level shift amount ΔV in FIG. 3 applied to the liquid crystal of the LCD panel 1 to generate digital video signals D₁′, D₂′, . . . , Dₘ′. That is, as shown in FIG. 3 which shows the drive voltage to transmittance characteristics of the LCD panel 1 of FIGS. 1A and 1B, the level shift amount ΔV is a preset voltage to initiate the change of the transmittance of the liquid crystal.

The D/A converter 205 performs D/A conversions upon the shifted digital video signals D₁′, D₂′, . . . , Dₘ′, using the multi-gradation voltages of the multi-gradation voltage generating circuit 206 to generate analog voltages which are applied via the output buffer 207 to signal lines SL₁, SL₂, . . . , SLₙ, respectively.

The output buffer 207 is constructed by voltage followers.

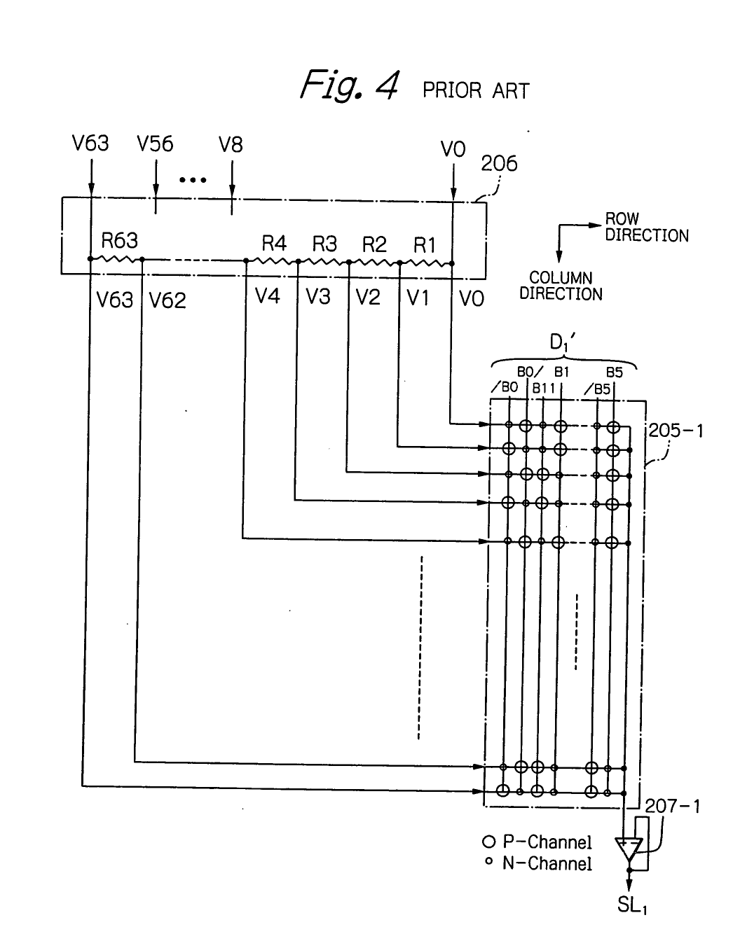

In FIG. 4, which is a detailed circuit diagram of the multi-gradation voltage generating circuit 206 of FIG. 2, if each of the digital video signals D₁′, D₂′, . . . , Dₙ′ is formed by six bits /B0, B0, /B1, B1, . . . , /B5, B5, the multi-gradation voltage generating circuit 206 is constructed by a series of resistors R1, R2, . . . , R63 for generating 64(=2⁶) gradation voltages V0, V1, . . . , V63. In this case, V0, V8, V16, V24, V32, V40, V48, V56 and V63 are reference gradation voltages supplied from the exterior, so that the differences ΔT in transmittance between the gradation voltages are made equivalent. For example, the reference gradation voltages such as V63 on the lower gradation voltage are made lower, and the reference gradation voltage on the higher gradation voltage such as V0 is made higher. Otherwise, (Vₙ−Vₙ₋₁)/R is constant,
where Vₙ is an n-th reference gradation voltage such as V8;
Vₙ₋₁ is an (n−1)-th reference gradation voltage such as V0; and
R is the resistance value between points supplied with the n-th reference gradation voltage and the (n−1)-th reference gradation voltage such as R1+R2+ . . . +R8. As a result, the power consumption can be decreased.

In FIG. 4, the resistors R1, R2, . . . , R63 have the adequate values. As a simplest example, the following conditions are satisfied:
R1=R2= . . . =R8
R9=R10= . . . =R16
R17=R18= . . . =R24
R25=R26= . . . =R32
R33=R34= . . . =R40
R41=R42= . . . =R48
R49=R50= . . . =R56
R57=R58= . . . =R63

Also, in FIG. 4, note that reference numeral 205-1 designates one D/A section of the D/A converter 205 for the shifted digital video signal D₁′; and 207-1 designates one output buffer section of the output buffer 207 for the signal line SL₁. Note that this D/A section can be constructed by CMOS switches as illustrated in FIG. 4.

In the multi-gradation voltage generating circuit 206 of FIG. 4, however, since the number of resistors corresponds to the number of required gradation voltages, the size of the multi-gradation voltage generating circuit 206 along the row direction is large, so that the LCD apparatus is increased in size. Particularly, when the COG method is adopted, the size of the glass substrate 5 is increased, which increases the size of the LCD apparatus.

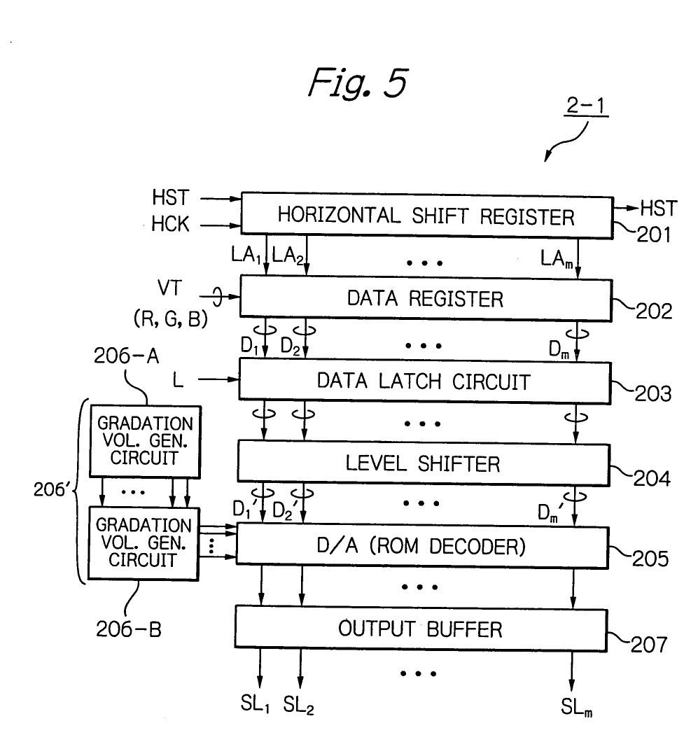

In FIG. 5, which illustrates an embodiment of the signal line driver according to the present invention, the multi-gradation voltage generating circuit 206 of FIG. 2 is replaced by a multi-gradation voltage generating circuit 206′ which is constructed by two gradation voltage generating circuits 206-A and 206-B.

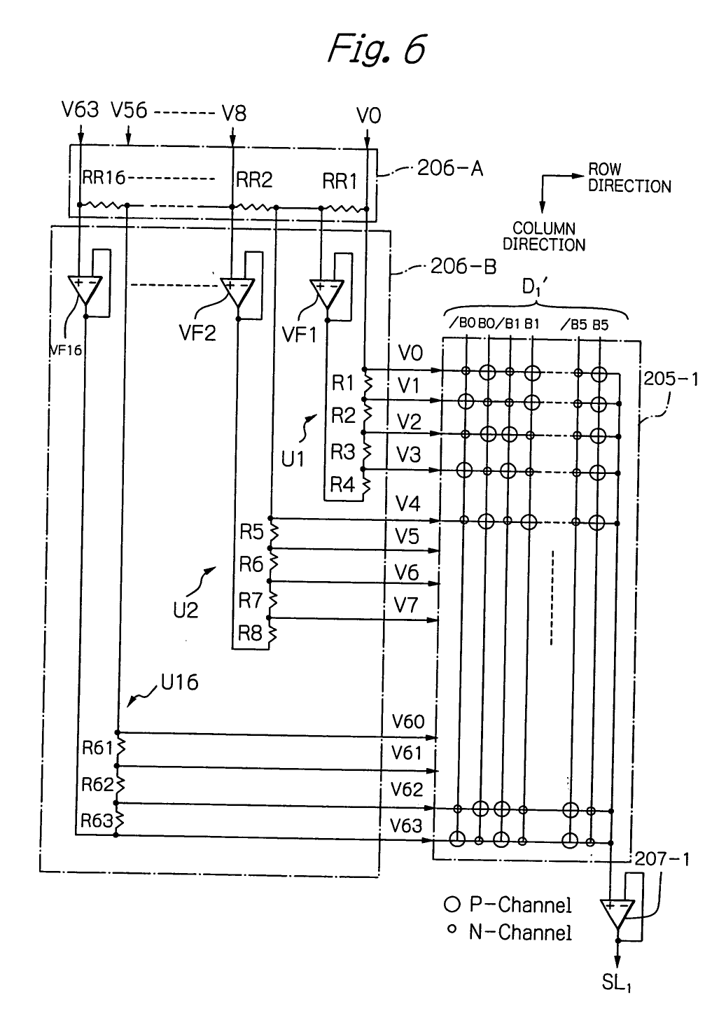

A first example of the gradation voltage generating circuits 206-A and 206-B are illustrated in FIG. 6.

The gradation voltage generating circuit 206-A is constructed by a series circuit of resistors RR1, RR2, . . . , RR16. In this case, the series circuit has an end for receiving a reference gradation voltage V0 from the exterior and the other end for receiving a reference gradation voltage V63 from the exterior. Also, the node between the resistors RR2 and RR3 receives a reference gradation voltage V8 from the exterior, the node between the resistors RR4 and RR5 receives a reference gradation voltage V16 from the exterior, the node between the resistors RR6 and RR7 receives a reference gradation voltage V24 from the exterior, the node between the resistors RR8 and RR9 receives a reference gradation voltage V32 from the exterior, the node between the resistors RR10 and RR11 receives a reference gradation voltage V40 from the exterior, the node between the resistors RR12 and RR13 receives a reference gradation voltage V48 from the exterior, the node between the resistors RR14 and RR15 receives a reference gradation voltage V56 from the exterior. However, note that only the reference gradation voltages V0 and V63 can be supplied from the exterior.

In the gradation voltage generating circuit 206-B, unit circuits U1, U2, . . . , U16 are provided and are connected to the resistors RR1, RR2, . . . , RR16, respectively. In this case, the unit circuit U1 is constructed by a voltage divider formed by resistors R1, R2, R3 and R4 and a voltage follower VF1, the unit circuit U2 is constructed by a voltage divider formed by resistors R5, R6, R7 and R8 and a voltage follower VF2, and the unit circuit U16 is constructed by a voltage divider formed by resistors R61, R62 and R63 and a voltage follower VF16.

Additionally, the following conditions are satisfied:
RR1=R1+R2+R3+R4
RR2=R5+R6+R7+R8
. . .
RR16=R61+R62+R63

Thus, the gradation voltages V0, V1, . . . , V63 are obtained in the same way as n FIG. 4. In FIG. 6, the resistors RR1, RR2, . . . , RR16 are required as compared with the multi-gradation voltage generating circuit 206 of FIG. 4. However, the number of the resistors RR1, RR2, . . . , RR16 of the gradation voltage generating circuit 206-A along the row direction is smaller that of the resistors R1, R2, . . . , R63 along the row direction of the multi-gradation voltage generating circuit 206 of FIG. 4. Note that, since the resistors R1, R2, . . . , R63 of FIG. 6 are arranged along the column direction, the resistors R1, R2, . . . , R63 do not affect the size of the LCD apparatus along the row direction.

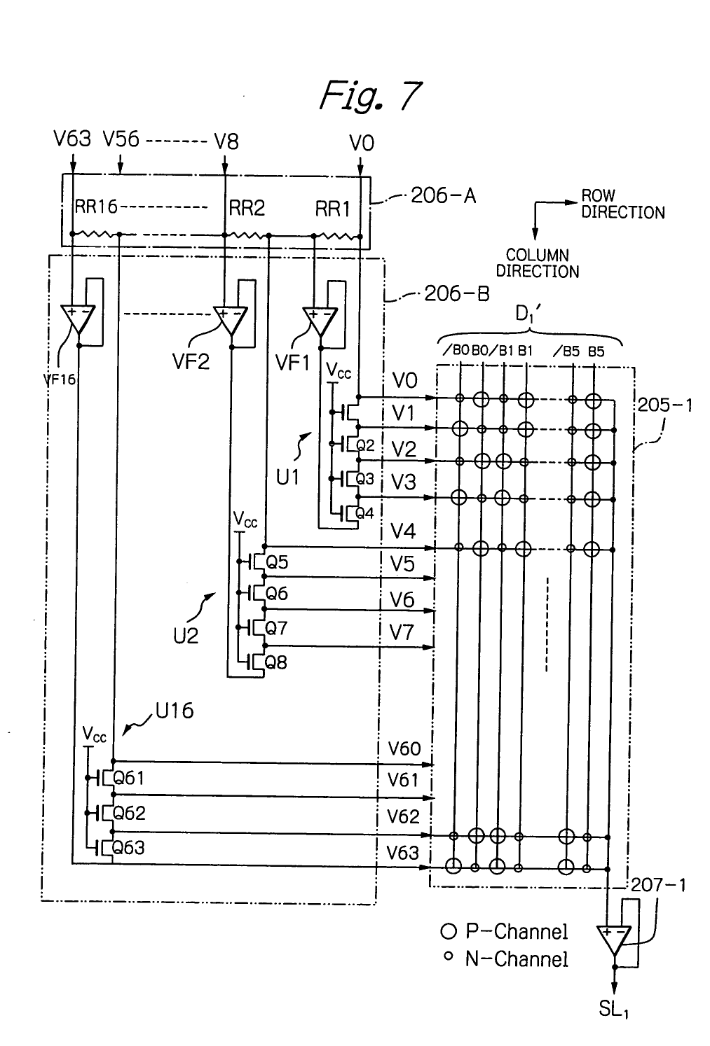

A second example of the gradation voltage generating circuits 206-A and 206-B are illustrated in FIG. 7.

In FIG. 7, the resistors R1, R2, . . . , R63 of FIG. 6 are replaced by normally-ON MOS transistors Q1, Q2, . . . , Q63, respectively. In this case, if the MOS transistor Qi has a gate length Wi and a gate length Li, respectively, the following conditions are satisfied:
L1/W1=R1
L2/W2=R2
. . .
L63/W63=R63

In FIGS. 6 and 7, additional power consumption is dissipated in the gradation voltage generating circuit 206-B. In order to decrease such additional power consumption, the gradation voltage generating circuit 206-B is controlled by a decoder 208 which receives the data bits /B2, B2, /B3, B3, /B4, B4, /B5 and B5 from the level shifter 204 of FIG. 2.

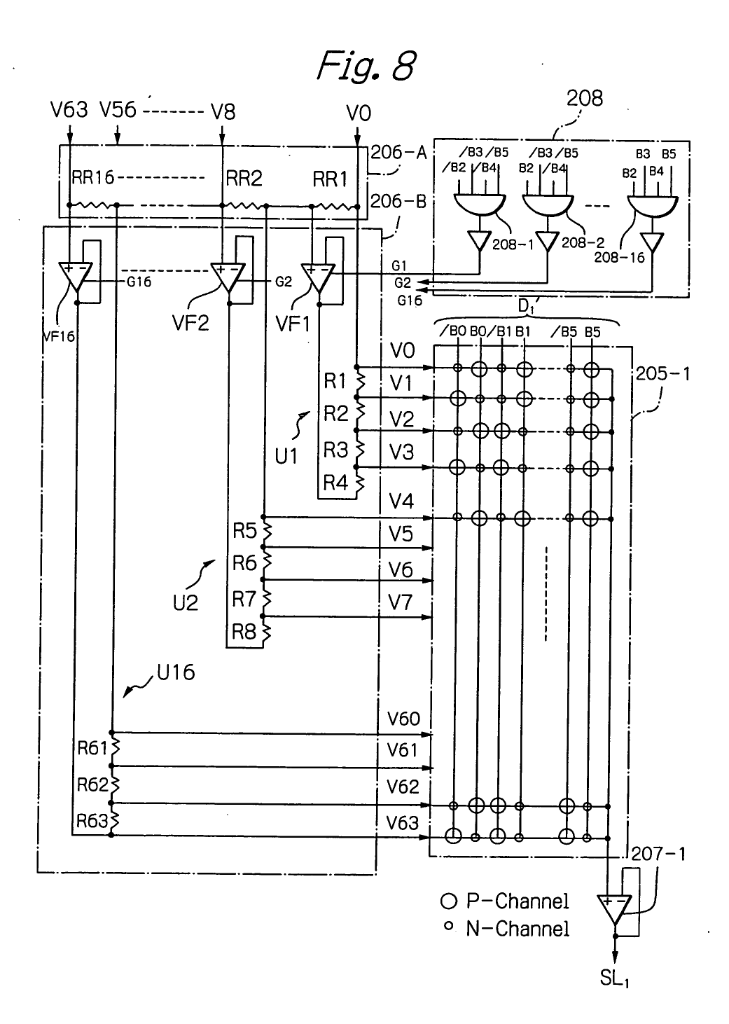

In FIG. 8, which is a modification of the circuit of FIG. 6, the decoder 208 is constructed by an AND circuit 208-1 for receiving the data bits /B2, /B3, /B4 and /B5 to turn ON and OFF the voltage follower VF1, an AND circuit 208-2 for receiving the data bits B2, /B3, /B4 and /B5 to turn ON and OFF the voltage follower VF2, . . . , an AND circuit 208-16 for receiving the data bits B2, B3, B4 and B5 to turn ON and OFF the voltage follower VF16.

For example, when the D/A converter section 205-1 selects the gradation voltage V0, only the voltage follower VF1 is turned ON while the other voltage followers VF2, . . . , VF16 are turned OFF, thus decreasing the power consumption.

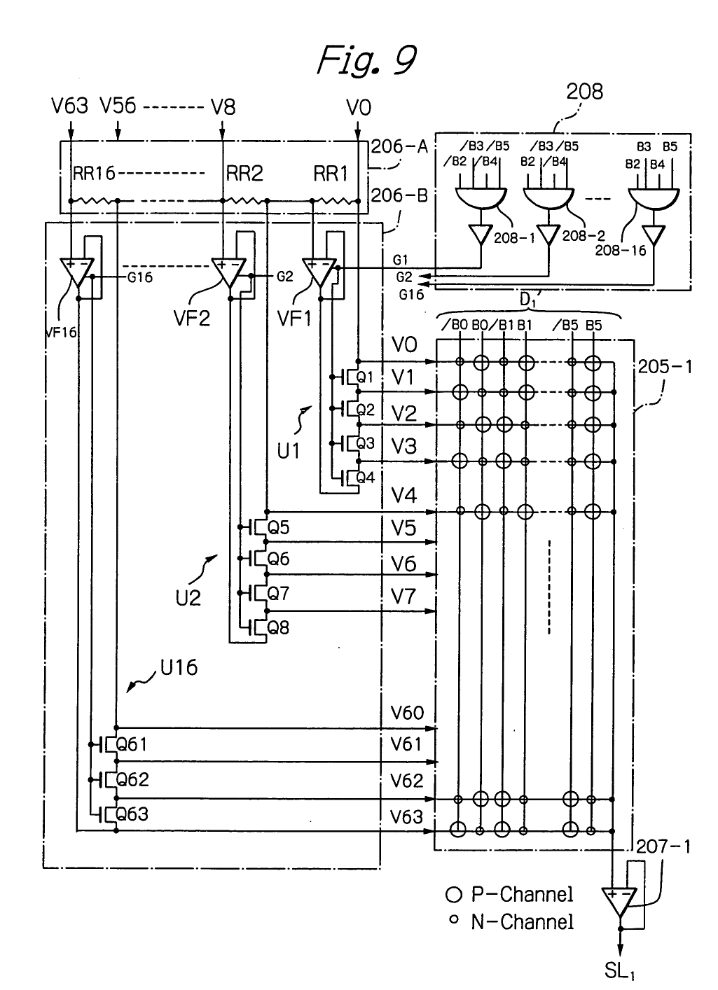

In FIG. 9, which is a modification of the circuit of FIG. 7, the decoder 208 also controls the MOS transistors Q1, Q2, . . . , Q63. That is, the AND circuit 208-1 is connected to the gates of the MOS transistors Q1, Q2, Q3 and Q4, the AND circuit 208-2 is connected to the gates of the MOS transistors Q5, Q6, Q7 and Q8, . . . , and the AND circuit 208-16 is connected to the gates of the MOS transistors Q61, Q62 and Q63.

For example, when the D/A converter section 205-1 selects the gradation voltage V0, only the voltage follower VF1 as well as the MOS transistors Q1, Q2, Q3 and Q4 are turned ON while the other voltage followers VF2, . . . , VF16 as well as the other MOS transistors Q5, Q6, . . . , and Q63 are turned OFF, thus further decreasing the power consumption.

As explained hereinabove, according to the present invention, the size of a multi-gradation voltage generating circuit along one direction can be decreased, and an LCD apparatus including such a multi-gradation voltage generating circuit can also be decreased in size.

1. A multi-gradation voltage generating apparatus comprising:
a first gradation voltage generating circuit including a series circuit formed by “M” (M=1, 2, . . . ) resistors, said series circuit having a first end adapted to receive a first reference gradation voltage and a second end adapted to receive a second reference gradation voltage;
a second gradation voltage generating circuit including “M” unit circuits each connected between ends of one of said resistors,
each of said unit circuits comprising one voltage divider and one voltage follower connected in series, said voltage divider being adapted to generate a plurality of gradation voltages.

2. The multi-gradation voltage generating apparatus as set forth in claim 1, wherein said voltage follower of one of said unit circuits is turned ON when one of said gradation voltages belonging to said one of said unit circuits is selected.

3. The multi-gradation voltage generating apparatus as set forth in claim 1, wherein said voltage divider comprises a plurality of serially-connected resistors each adapted to generate one of said gradation voltages.

4. The multi-gradation voltage generating apparatus as set forth in claim 1, wherein said voltage divider comprises a plurality of serially-connected MOS transistors each adapted to generate one of said gradation voltages.

5. The multi-gradation voltage generating apparatus as set forth in claim 4, wherein said MOS transistors of one of said unit circuits are turned ON when one of said gradation voltages belonging to said one of said unit circuits is selected.

6. The multi-gradation voltage generating apparatus as set forth in claim 3, wherein the resistors of said series circuit are arranged along a first direction, and said serially-connected resistors are arranged along a second direction perpendicular to said first direction.

7. The multi-gradation voltage generating apparatus as set forth in claim 4, wherein the resistors of said series circuit are arranged along a first direction, and said serially-connected MOS transistors are arranged along a second direction perpendicular to said first direction.

8. The multi-gradation voltage generating apparatus as set forth in claim 1, wherein a resistance value of the voltage divider of each of said unit circuits is about the same as a resistance value of a corresponding one of said resistors.

9. A signal line driver adapted to drive signal lines of a liquid crystal panel, comprising:
a multi-gradation voltage generating circuit including a first gradation voltage generating circuit including a series circuit formed by “M” (M=1, 2, . . . ) resistors, said series circuit having a first end adapted to receive a first reference gradation voltage from the exterior and a second end adapted to receive a second reference gradation voltage from the exterior, a second gradation voltage generating circuit including “M” unit circuits each connected between ends of one of said resistors, each of said unit circuits comprising one voltage divider and one voltage follower connected in series, said voltage divider being adapted to generate a plurality of gradation voltages; and
a first decoder, connected to said second gradation voltage generating circuit, said first decoder being adapted to select one of said gradation voltages and apply it to one of said signal lines.

10. The signal line driver as set forth in claim 9, further comprising a second decoder connected to said second gradation voltage circuit, said second decoder being adapted to turn ON said voltage follower of one of said unit circuits when said first decoder selects one of said gradation voltages belonging to said one of said unit circuits.

11. The signal line driver as set forth in claim 9, wherein said voltage divider comprises a plurality of serially-connected resistors each adapted to generate one of said gradation voltages.

12. The signal line driver as set forth in claim 9, wherein said voltage divider comprises a plurality of serially-connected MOS transistors each adapted to generate one of said gradation voltages.

13. The signal line driver as set forth in claim 12, further comprising a third decoder turns ON said MOS transistors of one of said unit circuits are turned ON when said first decoder selects one of said gradation voltages belonging to said one of said unit circuits.

14. The signal line driver as set forth in claim 11, wherein the resistors of said series circuit are arranged along a first direction, and said serially-connected resistors are arranged along a second direction perpendicular to said first direction.

15. The signal line driver as set forth in claim 12, wherein the resistors of said series circuit are arranged along a first direction, and said serially-connected MOS transistors are arranged along a second direction perpendicular to said first direction.

16. The signal line driver as set forth in claim 9, wherein a resistance value of the voltage divider of each of said unit circuits is about the same as a resistance value of a corresponding one of said resistors.
